(19) United States
(12) Patent Application Publication
(10) Pub. No.: US 2022/0215064 A1
(43) Pub. Date: Jul. 7, 2022

(54) REFINING INTERNET SEARCH RECOMMENDATIONS

(71) Applicant: INTERNATIONAL BUSINESS MACHINES CORPORATION, ARMONK, NY (US)

(72) Inventors: Jing James Xu, Xi'an (CN); YI SHAO, XIAN (CN); Xiao Ling Yang, Xi'an (CN); Lei Gao, XIAN (CN)

(21) Appl. No.: 17/140,608

(22) Filed: Jan. 4, 2021

(51) Int. Cl. G06F 16/9538; G06F 16/9535; G06F 16/9536; G06F 11/34

(52) U.S. Cl. CPC G06F 16/9538; G06F 11/3438; G06F 16/9536; G06F 16/9535

(57) ABSTRACT

A method, a computer program product and a computer system refine Internet search recommendations. The method includes receiving a search input from a user. The method also includes receiving a plurality of sets of search results from respective search engines. Each search engine utilizes a respective type of search process. Each of the sets of the search results for a selected one of the search engines is prioritized according to the type of the search process. The method further includes applying respective weights to the search engines such that the sets of search results have a modified priority based on the weights. The weights are associated with the user. Finally, the method includes generating modified search results based on the sets of search results, the weights, and the modified priority.

### FIELD

Embodiments relate, generally, to the field of computing, and more specifically to weighting and refining Internet search recommendations.

### BACKGROUND

The exponential growth of information that is available to the average person on the Internet has developed an environment where the amount of on-line information vastly outstrips any person's capability to survey it. This has given rise to a market for Internet search engines, where the user may enter a specific query and receive a list of items that match the query, usually ranked by the degree of the match. Over time, the field of machine learning has also rapidly matured and this has led to search engine providers being able to include “recommendation systems” that provide custom, personalized recommendations of the most interesting and useful items in the list to the user by ordering search results according to a weight or score. There are multiple recommendation techniques that are used in the field. One example is “collaborative” techniques that aggregate ratings of items by one or more users, recognize certain commonalities between users based on those ratings and then generate new recommendations based on the relationship between users. Another example is “content-based” techniques, where items of interest are defined by their features, then a user profile of desired features is developed based on past ratings of items by the user. Recommendation systems are frequently implemented as enhancements to search engines to provide users with a more meaningful and helpful way to search the vast information ocean of the Internet.

### SUMMARY

An embodiment is directed to a computer-implemented method for refining Internet search recommendations. The method may include receiving a search input from a user. The method may also include receiving a plurality of sets of search results from respective search engines, each search engine utilizing a respective type of search process. Each of the sets of the search results for a selected one of the search engines may be prioritized according to the type of the search process. In addition, the method may include applying respective weights to the search engines such that the sets of search results have a modified priority based on the weights. The weights may be associated with the user. The method may further include generating modified search results based on the sets of search results, the weights, and the modified priority.

The method may also include transmitting the modified search results to the user. The method may further include monitoring user interactions of the user in navigating the modified search results. Lastly, the method may include updating the weights of the search engines based on the user interactions.

In addition to a computer-implemented method, additional embodiments are directed to a system and a computer program product for refining Internet search recommendations.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 depicts a block diagram of a computing system that facilitates searching the Internet by a user, according to an exemplary embodiment.

FIG. 2 depicts a flowchart of a method for refining Internet search engine recommendations, according to an exemplary embodiment.

FIG. 3 depicts a block diagram of internal and external components of the computers and servers depicted in FIG. 1, according to at least one embodiment.

FIG. 4 depicts a cloud computing environment according to an exemplary embodiment.

FIG. 5 depicts abstraction model layers according to an exemplary embodiment.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a method of refining recommendations for Internet searches to accurately consider the disparate techniques that may be used to provide recommendations. In this method, multiple sets of recommendations from various search engines may be used as input and the method may filter those recommendations for a specific user and/or search engine. Use of results from only one technique may lead to a skewing of results and the user's intention may be lost. Therefore, a technique that can collect results from one or more search engines, identify the user and search engine and then re-order the results based on these custom factors, as well as continuously update itself to provide the most accurate results, may be useful.

Recommendation systems produce individualized recommendations as output or guide the user in a customized way to interesting or useful search results in a large space of possible options. Such systems have an obvious appeal in an environment where the amount of online information vastly outstrips any individual's capability to survey it. Recommendation systems are now an integral part of some e-commerce sites and popular Internet search engines.

Recommendation systems are not the same as search engines. The purpose of a search engine is to return all those items that match a query ranked by the degree of the match. A search engine may refine a search by attempting to modify the user's search terms, and crudely provide recommendations to the user, but a recommendation system is functionally separate from a search engine. Recommendation systems have background data, or the information that the system has before the recommendation process begins, input data, or the information that the user must communicate to the system in order to generate a recommendation, and also an algorithm that combines the background and input data to arrive at its suggestions. All of the known recommendation techniques have strengths and weaknesses, and many combinations of techniques have been chosen to achieve peak performance.

Collaborative recommendation techniques are probably the most familiar, most widely implemented and most mature of the technologies. Collaborative systems aggregate ratings or recommendations of objects and match the current user with other users that have similar behaviors or interests. Recommendations are then generated based on these inter-user comparisons, e.g., once User A and User B have been matched to each other, any items that are favorably rated by User A but have not yet been rated by User B would be recommended to User B. These systems can be either memory-based, comparing users against each other directly using correlation or other measures, or model-based, in which a model is derived from the historical rating data and used to make predictions via machine learning. This has been called “people-to-people correlation”.

Content-based recommendation is an outgrowth and continuation of information filtering research. In a content-based system, the objects of interest are defined by their associated features. A content-based system learns a profile of the user's interests based on the features present in objects the user has rated, which leads to the technique being called “item-to-item correlation.”

Demographic techniques aim to categorize the user based on personal attributes and make recommendations based on demographic classes. The benefit of a demographic approach is that it may not require a history of user ratings of the type needed by collaborative and content-based techniques.

Utility-based and knowledge-based systems do not attempt to build long-term generalizations about their users, but rather base their advice on an evaluation of the match between a user's need and the set of options available. Utility-based systems make suggestions based on a computation of the utility of each object for the user. The benefit of a utility-based recommendation is that it can factor non-product attributes, such as vendor reliability and product availability, into the utility computation, making it possible for example to trade off price against delivery schedule for a user who has an immediate need. Knowledge-based systems suggest objects based on inferences about a user's needs and preferences. Knowledge-based approaches have knowledge about how a particular item meets a particular user's need and can therefore reason about the relationship between a need and a possible recommendation.

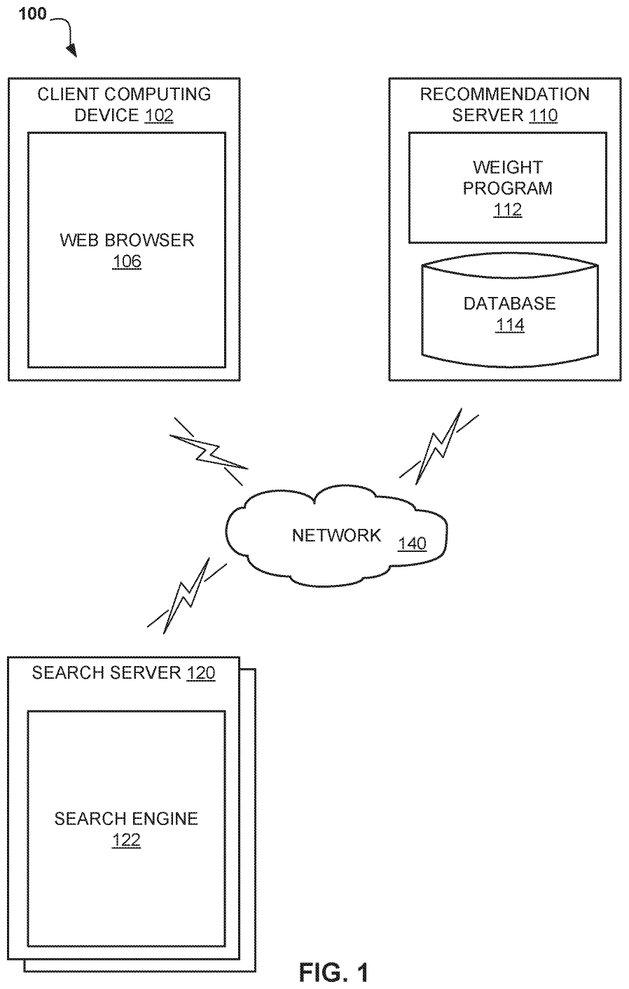

Referring now to FIG. 1, a block diagram of a computing system that may be used to search the Internet by a user is depicted, according to at least one embodiment. The networked computer environment 100 may include a client computing device 102, a recommendation server 110 and one or more search servers 120, interconnected via a communication network 140. According to at least one implementation, the networked computer environment 100 may include a plurality of client computing devices 102 of which only one is shown for illustrative brevity.

The communication network 140 may include various types of communication networks, such as a wide area network (WAN), local area network (LAN), a telecommunication network, a wireless network, a public switched network and/or a satellite network. The communication network 140 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements. Accordingly, the communication network 140 may represent any communication pathway between the various components of the networked computer environment 100.

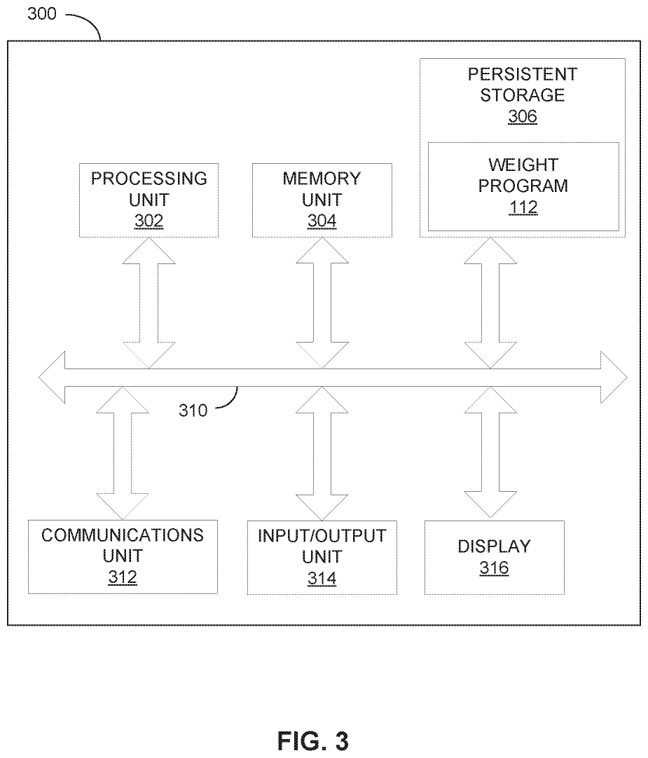

Client computing device 102 may include a web browser 106 displaying a search engine website and configured to communicate with at least one of the search servers 120 via the communication network 140, in accordance with an exemplary embodiment. The web browser 106 may provide a user interface in which a user utilizing the client computing device 102 may enter a search input and receive search results where the search results are generated according to the exemplary embodiments. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include computing system 300.

The recommendation server 110 may be a laptop computer, netbook computer, personal computer (PC), a desktop computer, or any programmable electronic device or any network of programmable electronic devices capable of hosting and running a weight program 112 and a database 114. The recommendation server 110 is configured to receive search results as input from the one or more search servers 120 and generate a modified list of search results based on applying the output of the weight program 112 to the search servers 120. The weight program 112 may calculate weights to apply to the search servers 120 based on stored information about the user, e.g., user profile, and also stored information about the search engine 122, e.g., information about its recommendation technique. By applying a corresponding weight that is specific to the user to the search servers 120, the search results from the search servers 120 may be prioritized when generating the modified search results that is provided to the client computing device 102. The database 114 may be used to store user profile information, any information about the search engine 122, including any potential custom or default weights to apply in the stages of the method below, as well as the medium for updating the weights applied by the weight program 112 in the feedback stage described in the method below. For example, the database 114 may store user profiles corresponding to each user utilizing the features of the exemplary embodiments where each user profile may include historical information used to determine weights that are to be applied to the search servers 120.

The search server 120 may be a laptop computer, netbook computer, personal computer (PC), a desktop computer, or any programmable electronic device or any network of programmable electronic devices capable of hosting and running the search engine 122. The search engine 122 is configured to receive a search input from a user via the web browser 106 on the client computing device 102. The search server 120 is configured to process the search terms that are received from the user and return an ordered list of search results. The order of the list is determined by the search process that the search engine 122 and search server 120 are configured to utilize. It is noted that, without the exemplary embodiments, the search server 120 may transmit the determined search results to the user via the search engine 122 and web browser 106. However, according to the exemplary embodiments, the search server 120 may provide its search results to the recommendation server 110 for subsequent processing.

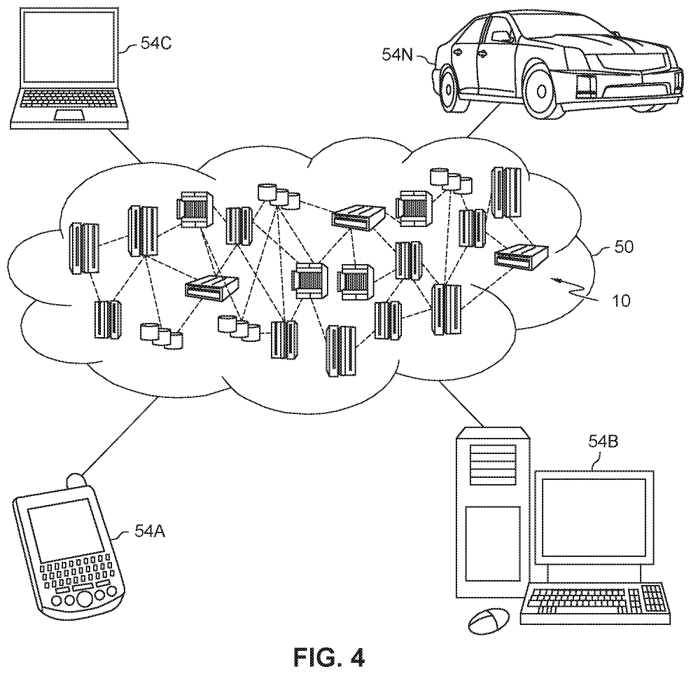

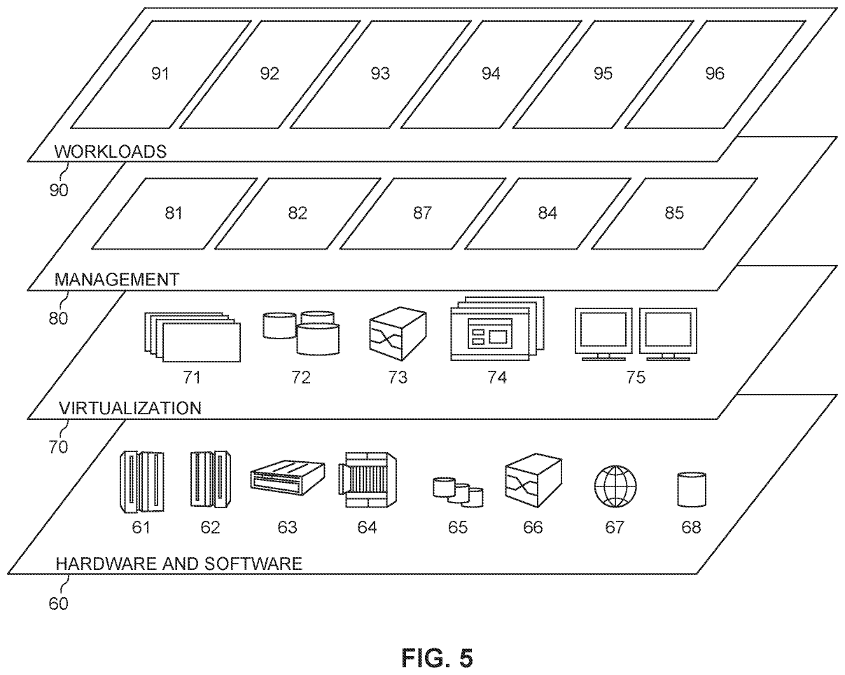

The recommendation server 110 and search server 120 may communicate with the client computing device 102 via the communication network 140, in accordance with embodiments of the invention. As will be discussed with reference to FIG. 3, the recommendation server 110 and search server 120 may each include computing system 300. As will be discussed with reference to FIGS. 4 and 5, the recommendation server 110 and search server 120 may also operate in a cloud computing service model, such as Software as a Service (SaaS), Platform as a Service (PaaS), or Infrastructure as a Service (IaaS). The recommendation server 110 and search server 120 may also be located in a cloud computing deployment model, such as a private cloud, community cloud, public cloud, or hybrid cloud.

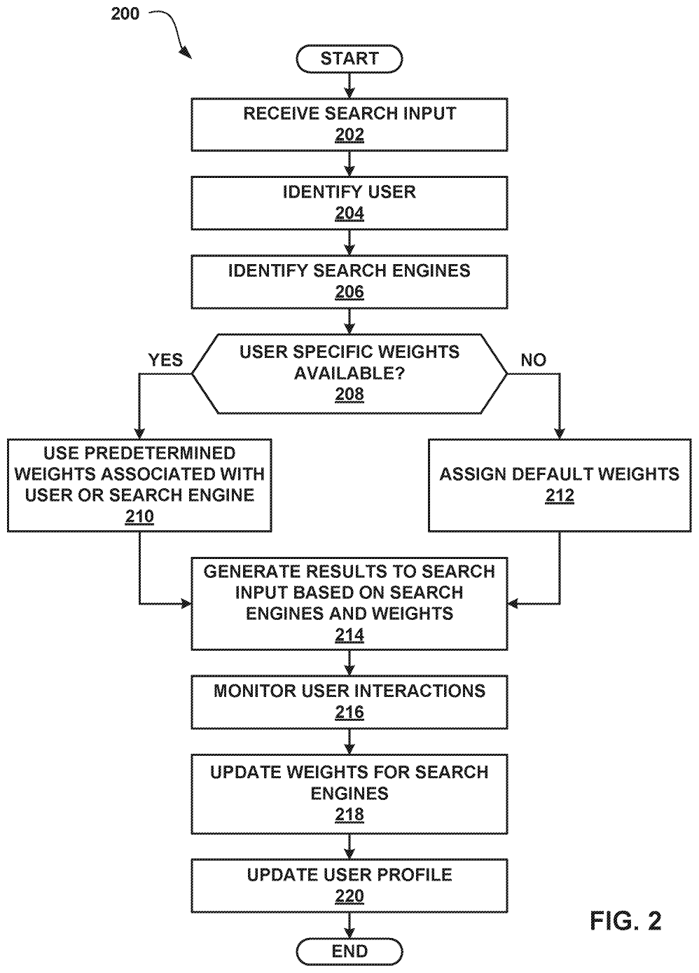

Referring to FIG. 2, an operational flowchart illustrating an Internet search recommendation refinement process 200 is depicted according to at least one embodiment. At 202, the recommendation server 110 receives a search input from a user via the web browser 106 on the client computing device 102. For example, a user wishes to conduct a search of the Internet and enters explicit search terms into the web browser 106 using an appropriate input device, e.g., mouse, keyboard, microphone, etc. As a result of providing a search input, a plurality of the search engines 122 may receive the search input to perform a search of the Internet and generate a respective list of weighted or scored results of the search. Each of the search engines 122 may generate its own set of results with the items scored and weighted by the internal processes of the search engine 122. It should be noted that these internal processes of the search engine 122 need not reside on the search server 120 and may include a separate recommendation program and algorithm from the search engine 122 itself. The search results from the search engines 122 may be gathered as sets of search results for input to the weight program 112, where each set corresponds to a particular one of the search engines 122.

At 204, the weight program 112 may interface with web servers to find an online history of the user, or user profile. Examples of available online historical data are purchase history, e.g., the user has bought a particular product or type of products more frequently, item category/attributes, e.g., the user only considers buying electronic devices that have fingerprint support, social network posts or profiles, e.g., the user blogged or shared interest in a product over his/her social network, IoT data, e.g., an IoT server in the cloud may have information on what the user is interested in, based on the data from his/her smart home and office, etc. This online historical data for the user may be analyzed and combined to generate, or add to, a user profile containing, for instance, a history of items purchased or viewed by the user, and interests of the user determined from social media. The profile data of the user may be analyzed to determine product category or attribute requirements of the user. Any analysis results may be stored in the database 114 for use in determining how to weight search results for the user. In addition, the user profile may indicate a preferred one of the search engines 122 for the user such that it may weight results from that search engine 122 accordingly or other search engines 122 that use a similar recommendation technique.

At 206, the weight program 112 may determine the various search engines 122 for which the modified search results may be based. For example, a user may enter the search terms “best computer printer”, expecting a list of results that includes product recommendations. A search history of the user may indicate the search engines 122 that have been used. In another example, the recommendation server 110 may be associated with a plurality of the search engines 122 that are to be used in generating the modified search results. By identifying the search engines 122, the weight program 112 may determine an appropriate weight for search results that come from the specific search engine in addition to the weight information that comes from the user profile of the user who submitted the search input. The weight program 112 may determine each search engine 122 that is in use separately. There are also many types of recommendation techniques that may be used by different search engines 122 and there may be multiple search engines 122 using the same type. It should also be noted that it is not necessary to identify the exact search engine 122 by name but rather the type of recommendation technique that the search engine 122 uses.

At 208, the weight program 112 may determine from the user profile that may be created or accessed at 204 and the identification of the search engine 122 at 206 whether or not its database 114 contains specific weights for the users and search engines 122 that may be applied to the search results gathered at 202. If the weight program 112 identifies a set of specific weights that it may use, those weights may be assigned to the search results at step 210. If there are no specific weights already available for the user, the weight program 112 may assign a set of predetermined default weights to the search results at step 212. At either stage 210 or 212, because each search engine 122 may output its own recommendation score for each search result, it may be necessary to normalize the recommendation scores of the search engines 122, e.g., into the range of 0 to 1, prior to assignment by the weight program 112. The initial preference weight that is assigned, whether default or retrieved from a user profile, may also be calculated for each recommendation engine based on the number of search engines 122 that are used in the initial search. For example, if there are K search engines 122 that were used with the search terms, the initial weight for each search engine may be adjusted by a factor of 1/K.

At 214, the weight program 112 may apply the assigned weight to each search server 120 and compute a final recommendation weight or score that may be the product of the weight assigned by the search engine 122 and the assigned weight from the weight program 112. All results from the search engines 122 may be scored in this way through weighting the search server 120 and a mixed recommendation list may be displayed to the user without regard to the search engine 122 that produced the original result. The mixed recommendation list may be presented to the user in weighted or scored order, such that the highest recommendation weight or score is at the top of the list.

At 216, the weight program 112 may log user interactions with the mixed recommendation list, such as a number of clicks on a search result or the time spent on specific search results or any other action that a user takes in browsing the mixed recommendation list that is being displayed. The number of interactions may be accumulated as feedback for each search engine 122 separately during a configured time window. For example, if there are two (2) search engines 122 being used, and for the first search engine there are m interactions logged, and n interactions logged for the second search engine during the last business week, a new user focusing weight for each search engine may be calculated based on the accumulated user feedback. This user focusing weight, wf, may be normalized to the range of 0 to 1 and in the referenced example, wf for the first search engine would be m/(m+n), and wf for the second search engine would be n/(m+n). It should be noted that the feedback may be used to adjust the weights that are assigned in steps 210 or 212 and applied in step 214 and this is just one sample calculation to make that update.

At 218, the weight program 112 may update its database 114 such that the weight assigned to a specific search engine may be adjusted by the user focusing weight wf that was calculated in 216. As an example, a preference weight wp may already be associated with the search engine 122 within the database 114 from the initial identification of the search engine 122 or from a previous profile update. At step 218, this preference weight wp for search engine 122 may be updated as wp+α*(wf−wp) where α is an update factor to control how fast the feedback will be applied into hybrid recommendation results. In this way, the weight program 112 is consistently updating its database 114 to provide appropriate weights for ordering mixed recommendation lists that may be received.

At 220, the weight program 112 may also use the information gathered at the feedback stage 216 to update the specific weights in the user profile that may be used in subsequent runs of the weight program 112 at step 210. For example, if the user has expressed through interacting with the search results that they prefer certain recommendations, the weight program 112 may update the weight that is calculated for that set of search engine 122 and user to weight those results more heavily. When the weight program 112 assigns weights to search results again for that user, the results from the preferred search engine 122 will be higher in the resulting list and increase the user's satisfaction with the results.

Referring to FIG. 3, a block diagram is depicted illustrating a computer system 300 which may be embedded in the client computing device 102, the recommendation server 110 and search server 120 depicted in FIG. 1 in accordance with an embodiment. It should be appreciated that FIG. 3 provides only an illustration of one implementation and does not imply any limitations with regard to the environments in which different embodiments may be implemented. Many modifications to the depicted environments may be made based on design and implementation requirements.

As shown, a computer system 300 includes a processor unit 302, a memory unit 304, a persistent storage 306, a communications unit 312, an input/output unit 314, a display 316, and a system bus 310. Computer programs such as the weight program 112, web browser 106 or search engine 122 are typically stored in the persistent storage 306 until they are needed for execution, at which time the programs are brought into the memory unit 304 so that they can be directly accessed by the processor unit 302. The processor unit 302 selects a part of memory unit 304 to read and/or write by using an address that the processor 302 gives to memory 304 along with a request to read and/or write. Usually, the reading and interpretation of an encoded instruction at an address causes the processor 302 to fetch a subsequent instruction, either at a subsequent address or some other address. The processor unit 302, memory unit 304, persistent storage 306, communications unit 312, input/output unit 314, and display 316 interface with each other through the system bus 310.

Examples of computing systems, environments, and/or configurations that may be represented by the data processing system 300 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 300 also includes a communications unit 312 such as TCP/IP adapter cards, wireless Wi-Fi interface cards, or 3G or 4G wireless interface cards or other wired or wireless communication links. The web browser 106 in the client computing device 102, the weight program 112 in the recommendation server 110 and the search engine 122 in the search server 120 may communicate with external computers via a network (for example, the Internet, a local area network or other wide area network) and respective network adapters or interfaces 312. From the network adapters or interfaces 312, the web browser 106 in the client computing device 102, the weight program 112 in the recommendation server 110 and the search engine 122 in the search server 120 are loaded into the respective persistent storage 306. The network may comprise copper wires, optical fibers, wireless transmission, routers, firewalls, switches, gateway computers and/or edge servers.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 610 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Internet search recommendation refining 96.

Embodiments of the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for refining Internet search recommendations comprising:
receiving a search input from a user;
generating a plurality of sets of search results using respective search engines, each search engine utilizing a respective type of recommendation, each set of search results for a selected one of the search engines being associated with a recommendation score based on the type of the recommendation;
applying respective weights to the recommendation scores such that each set of search results has a modified score based on the weights, the weights being associated with the user;
generating modified search results based on the plurality of sets of search results, the weights, and the modified score; and
displaying the modified search results in order of the modified score to the user.

2. The computer-implemented method of claim 1, wherein the weights are based on historical information associated with previous searches performed by the user.

3. The computer-implemented method of claim 1, wherein the weights are set as default weights absent historical information associated with previous searches performed by the user.

4. The computer-implemented method of claim 3, wherein the default weights are an even distribution among the search engines.

5. The computer-implemented method of claim 1, further comprising:
monitoring user interactions of the user in navigating the modified search results; and
updating the weights based on the user interactions.

6. The computer-implemented method of claim 5, wherein the user interactions are indicative of a respective focusing score of the search engines, the weights being updated based on the focusing scores and a respective preference weight of the search engines.

7. The computer-implemented method of claim 1, wherein the type of recommendation being one of a collaborative recommendation or a content-based recommendation.

8. A computer program product for refining Internet search recommendations, the computer program product comprising:
a computer-readable storage device storing computer: readable program code embodied therewith, the computer-readable program code comprising program code executable by a computer to perform a method comprising:
receiving a search input from a user;
generating a plurality of sets of search results using respective search engines, each search engine utilizing a respective type of recommendation, each set of search results for a selected one of the search engines associated with a recommendation score based on the type of the recommendation;
applying respective weights to the recommendation scores such that each set of search results has a modified score based on the weights, the weights being associated with the user;
generating modified search results based on the plurality of sets of search results, the weights, and the modified score; and
displaying the modified search results in order of the modified priority to the user.

9. The computer program product of claim 8, wherein the weights are based on historical information associated with previous searches performed by the user.

10. The computer program product of claim 8, wherein the weights are set as default weights absent historical information associated with previous searches performed by the user.

11. The computer program product of claim 10, wherein the default weights are an even distribution among the search engines.

12. The computer program product of claim 8, further comprising:
monitoring user interactions of the user in navigating the modified search results; and
updating the weights based on the user interactions.

13. The computer program product of claim 12, wherein the user interactions are indicative of a respective focusing score of the search engines, the weights being updated based on the focusing scores and a respective preference weight of the search engines.

14. The computer program product of claim 8, wherein the type of recommendation being one of a collaborative recommendation or a content-based recommendation.

15. A computer system for refining Internet search recommendations, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving a search input from a user;
generating a plurality of sets of search results using respective search engines, each search engine utilizing a respective type of recommendation, each set of search results for a selected one of the search engines being associated with a recommendation score based on the type of the recommendation;
applying respective weights to the search engines such that each set of search results has a modified score based on the weights, the weights being associated with the user;
generating modified search results based on the plurality of sets of search results, the weights, and the modified score; and
displaying the modified search results in order of the modified score to the user.

16. The computer system of claim 15, wherein the weights are based on historical information associated with previous searches performed by the user.

17. The computer system of claim 15, wherein the weights are set as default weights absent historical information associated with previous searches performed by the user.

18. The computer system of claim 17, wherein the default weights are an even distribution among the search engines.

19. The computer system of claim 15, further comprising:
monitoring user interactions of the user in navigating the modified search results; and
updating the weights based on the user interactions.

20. The computer system of claim 19, wherein the user interactions are indicative of a respective focusing score of the search engines, the weights being updated based on the focusing scores and a respective preference weight of the search engines.
